(19) United States
(12) Patent Application Publication
(10) Pub. No.: US 2019/0102496 A1
(43) Pub. Date: Apr. 4, 2019

(54) INTERACTIVE USER INTERFACE FOR COMPOSING QUANTUM CIRCUITS

(71) Applicant: INTERNATIONAL BUSINESS MACHINES CORPORATION, ARMONK, NY (US)

(72) Inventors: Lev S. Bishop, Dobbs Ferry, NY (US); Jerry M. Chow, White Plains, NY (US); Andrew W. Cross, Yorktown Heights, NY (US); Jay M. Gambetta, Yorktown Heights, NY (US); Ismael F. Sertage, Chappaqua, NY (US)

(21) Appl. No.: 15/720,745

(22) Filed: Sep. 29, 2017

(51) Int. Cl. G06F 17/50; G06F 3/0482; G06F 9/44

(52) U.S. Cl. CPC G06F 17/5022; G06F 3/0482; G06N 99/002; G06F 9/4446; G06F 8/33; G06F 8/34

(57) ABSTRACT

Systems, methods, and computer-readable media are disclosed for composing quantum circuits and rendering graphical representations thereof within an interactive user interface. The user interface may be a quantum circuits composer interface into which a quantum circuit can be written via drag-and-drop user interactions with the interface that involve placing symbols representative of quantum operations (gates and measurements) on interactive elements (e.g., linear elements) representing qubits and/or classical bits, or more specifically, the state of qubits/classical bits over time. Quantum circuits created using the quantum circuits composer interface can be translated into a scripting language. In addition, user commands provided via a command line interface (CLI) can be translated into a corresponding quantum circuit and a graphical representation thereof can be dynamically generated. Modifications to the code commands can be dynamically reflected in the graphical representation.

### BACKGROUND

Quantum circuits are representations of quantum computing algorithms based on particular sequences of quantum gates and measurements. However, conventional formulations for representing a quantum circuit, which entail mathematical representations using matrices and tensor products, are complex and non-intuitive to a user attempting to understand the operation of the quantum circuit. In particular, there is a need for a technical solution that provides a user-friendly, intuitive mechanism for composing quantum circuits capable of being executed on a quantum processor.

### SUMMARY

In one or more example embodiments of the disclosure, a computer-implemented method for composing a quantum circuit is disclosed. The method includes providing a user interface. The user interface includes a set of interactive elements corresponding to qubits of a physical quantum processor, where each interactive element represents a progression of quantum information over time in a respective qubit. The user interface further includes a set of symbols, where each symbol is representative of a corresponding operation capable of being performed on one or more of the qubits. The method further includes receiving user input indicative of: i) one or more symbols selected from the set of symbols, ii) a corresponding one or more interactive elements with which the one or more symbols are associated, and iii) a temporal order in which the one or more symbols are associated with the one or more interactive elements. The method additionally includes composing the quantum circuit based at least in part on the user input, where composing the quantum circuit includes generating and displaying a graphical representation of the quantum circuit that includes the one or more symbols rendered in association with the one or more interactive elements in accordance with the temporal order.

In one or more other example embodiments of the disclosure, a system for composing a quantum circuit is disclosed. The system includes at least one memory storing computer-executable instructions, and at least one processor configured to access the at least one memory and execute the computer-executable instructions to perform a set of operations. The operations include providing a user interface. The user interface includes a set of interactive elements corresponding to qubits of a physical quantum processor, where each interactive element represents a progression of quantum information over time in a respective qubit. The user interface further includes a set of symbols, where each symbol is representative of a corresponding operation capable of being performed on one or more of the qubits. The operations further include receiving user input indicative of: i) one or more symbols selected from the set of symbols, ii) a corresponding one or more interactive elements with which the one or more symbols are associated, and iii) a temporal order in which the one or more symbols are associated with the one or more interactive elements. The operations additionally include composing the quantum circuit based at least in part on the user input, where composing the quantum circuit includes generating and displaying a graphical representation of the quantum circuit that includes the one or more symbols rendered in association with the one or more interactive elements in accordance with the temporal order.

In one or more other example embodiments of the disclosure, a computer program product for composing a quantum circuit is disclosed that comprises a non-transitory storage medium readable by a processing circuit, the storage medium storing instructions executable by the processing circuit to cause a method to be performed. The method includes providing a user interface. The user interface includes a set of interactive elements corresponding to qubits of a physical quantum processor, where each interactive element represents a progression of quantum information over time in a respective qubit. The user interface further includes a set of symbols, where each symbol is representative of a corresponding operation capable of being performed on one or more of the qubits. The method further includes receiving user input indicative of: i) one or more symbols selected from the set of symbols, ii) a corresponding one or more interactive elements with which the one or more symbols are associated, and iii) a temporal order in which the one or more symbols are associated with the one or more interactive elements. The method additionally includes composing the quantum circuit based at least in part on the user input, where composing the quantum circuit includes generating and displaying a graphical representation of the quantum circuit that includes the one or more symbols rendered in association with the one or more interactive elements in accordance with the temporal order.

In one or more example embodiments of the disclosure, a web-based system for composing a quantum circuit is disclosed. The web-based system includes a server storing a graphical user interface (GUI) for composing the quantum circuit. The GUI includes a set of interactive elements corresponding to qubits of a physical quantum processor, where each interactive element represents a progression of quantum information over time in a respective qubit. The GUI further includes a set of symbols, where each symbol is representative of a corresponding operation capable of being performed on one or more of the qubits. The GUI enables selection of any symbol in the set of symbols and association of the selected symbol with one or more of the interactive elements. Association of the selected symbol with the one or more interactive elements indicates that the corresponding operation for the selected symbol is to be performed in the quantum circuit on one or more qubits corresponding to the one or more interactive elements.

In one or more example embodiments of the disclosure, a method for dynamically generating a graphical representation of a quantum circuit is disclosed. The method includes providing a command line interface and receiving commands through the command line interface in a gate representation language. The method further includes determining, based at least in part on the commands, a set of operations, a set of qubits to which the set of operations are to be applied, and a temporal order in which the set of operations is to be applied to the set of qubits. The method additionally includes generating and displaying the graphical representation of the quantum circuit. The graphical representation indicates a set of symbols corresponding to the set of operations and a set of linear interactive elements corresponding to the set of qubits, and placement of the set of symbols along the set of linear interactives elements indicates the temporal order.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 depicts a cloud computing environment in accordance with one or more example embodiments of the disclosure.

FIG. 2 depicts abstraction model layers in accordance with one or more example embodiments of the disclosure.

FIG. 3 is a schematic block diagram illustrating the composition of a quantum circuit using an interactive user interface in accordance with one or more example embodiments of the disclosure.

FIG. 4 is a schematic block diagram illustrating the dynamic generation of a graphical representation of a quantum circuit based on user commands in a gate representation language in accordance with one or more example embodiments of the disclosure.

FIG. 5 depicts an example interactive user interface for composing quantum circuits in accordance with one or more example embodiments of the disclosure.

FIG. 6 depicts an example quantum circuit that includes a subroutine and classical control of a quantum operation in accordance with one or more example embodiments of the disclosure.

FIG. 7 depicts user interactions with the interactive user interface to produce a controlled-NOT (CNOT) gate operation in accordance with one or more example embodiments of the disclosure.

FIG. 8 depicts dynamic generation of a graphical representation of a quantum circuit responsive to user commands entered via a command line interface (CLI) in accordance with one or more example embodiments of the disclosure.

FIG. 9 is a process flow diagram of an illustrative method for composing a quantum circuit using an interactive user interface in accordance with one or more example embodiments of the disclosure.

FIG. 10 is a process flow diagram of an illustrative method for modifying an interactive user interface in response to selection of a multi-qubit gate operation to indicate qubit(s) that are unavailable for selection for the multi-qubit gate operation in accordance with one or more example embodiments of the disclosure.

FIG. 11 is a process flow diagram of an illustrative method for generating and adding a subroutine to a quantum circuit composed using an interactive user interface in accordance with one or more example embodiments of the disclosure.

FIG. 12 is a process flow diagram of an illustrative method for dynamically generating a graphical representation of a quantum circuit responsive to user commands entered via a CLI in accordance with one or more example embodiments of the disclosure.

FIG. 13 is a schematic diagram of an illustrative networked architecture configured to implement one or more example embodiments of the disclosure.

### DETAILED DESCRIPTION

Disclosed herein are technical solutions that address the drawbacks associated with conventional formulations for representing a quantum circuit. In particular, example embodiments of the disclosure include, among other things, systems, methods, computer-readable media, techniques, and methodologies for composing quantum circuits and rendering graphical representations thereof within an interactive user interface that address the drawbacks associated with conventional quantum circuit formulations. The user interface may be a web-based or otherwise cloud-based quantum circuit composer interface. A quantum circuit can be written into the interface via drag-and-drop user interactions with the interface that involve placing symbols representative of quantum operations (gates and measurements) on interactive elements (e.g., linear elements) representing qubits and/or classical bits, or more specifically, the state of qubits/classical bits over time. The symbols may be placed at specific temporal nodes of the interactive elements so as to reflect a sequence of the underlying operations over time. Quantum circuits created using the quantum circuit composer interface disclosed herein can be translated into a scripting language which would otherwise be implemented via command line type interfaces. In addition, in certain example embodiments, user commands provided via a command line interface (CLI) can be translated into a corresponding quantum circuit and a graphical representation thereof can be dynamically generated. Modifications to the code commands can be dynamically reflected in the graphical representation.

More specifically, an interactive user interface for composing quantum circuits in accordance with example embodiments of the disclosure can include interactive elements representing qubits of a qubit register in a quantum processor. Each interactive element may be, for example, a line (e.g., a horizontal line) that indicates—in the direction in which it extends—a progression of time with respect to a particular qubit. More specifically, each interactive element may represent the state of a corresponding qubit over time.

The interactive user interface can also include various user-selectable symbols that may represent single-qubit gate operations, multi-qubit gate operations, a measurement operation, and other quantum computing operations that can be used to form a quantum circuit. The symbols are selectable by a user and can be positioned along one or more of the interactive elements. For example, a symbol representative of a single-qubit gate operation (e.g., a Hadamard gate operation) may be selected and superimposed on a linear interactive element corresponding to a qubit on which a user desires to execute the single-qubit gate operation. As another example, a symbol representative of a multi-qubit gate operation (e.g., a CNOT operation) may be selected and superimposed—through a series of user interactions—on multiple linear interactive elements representing multiple, different qubits on which the multi-qubit gate operation is to be performed.

In addition to the interactive elements representing qubits, the user interface may also include one or more interactive elements representing classical bits of a classical bit register. For example, a single linear interactive element (e.g., a horizontal line) may represent all bits in a classical bit register and may be expandable to show individual interactive elements corresponding to the various bits of the classical bit register. Users wishing to execute operations that involve both qubits and classical bits may make use of such interactive element(s) representing classical bits.

For example, a symbol representing a qubit measurement operation may be provided in the user interface. The measurement operation may measure the state of a qubit and represent the measurement as a classical bit value. A user may select the symbol representing a qubit measurement operation and superimpose the symbol (e.g., via a drag-and-drop operation) on an interactive element representing a qubit to be measured by the measurement operation. In certain example embodiments, the user may then extend the symbol to indicate a classical bit designated for storing the result of the measurement operation. For example, after superimposing the symbol on the interactive element representing the qubit to be measured, the user may perform a touch-based or cursor-based interaction with the user interface (e.g., a drag operation) from the interactive element representing the qubit to an interactive element representing a classical bit designated for storing the result of the measurement. A graphical indication (e.g., a line extending from the interactive element representing the selected qubit to the interactive element representing the selected classical bit) may be rendered on the user interface as a result of the user's drag operation.

In one or more other example embodiments, after the user selects and moves the symbol representing the measurement operation to a location along a particular interactive element representing a particular qubit (e.g., superimposes the symbol on the particular interactive element), the system may query the user to designate a classical bit in a classical bit register to which the measurement value is to be saved. The graphical indication described above may then be rendered on the user interface (e.g., a line extending from the interactive element corresponding to the selected qubit to an interactive element representing the classical bit). In certain example embodiments, if the interactive element is collapsed to represent all bits in a classical bit register together, the bit position designated by the user for storing the measurement value may be separately indicated. For example, a numeral indicating the bit position may be displayed in proximity to the graphical representation of the measurement operation.

While quantum computing has become accessible via cloud-based systems, such systems lack a mechanism for making the quantum computing power useable and programmable by individuals. The quantum circuit composer graphical user interface (GUI) disclosed herein for composing quantum circuits provides a user-friendly interface for generating quantum circuits that can be graphically represented in the interface in an intuitive manner, while at the same time, being correct from a physics perspective. Typically, the quantum circuits formalism is a particular representation of algorithms and different implementations of quantum gates and measurements. Within the quantum circuits formalism, it is possible to compose circuits that realize canonical quantum computing algorithms (e.g., Grover's , Deutsch-Jozsa, phase estimation, Shor's algorithm, etc.). Given a set of available gates and measurements, a quantum circuit includes a particular sequence of such gates and measurements spread across the computing register (either qubits or bits).

The GUI for composing quantum circuits in accordance with example embodiments avoids the complexity of the mathematical formulation of quantum circuits involving matrices and/or tensor products by providing a graphical representation of the composed quantum circuit that is easy to visualize and that provides an intuition as to how operations occur over time. A quantum circuit is a representation of how quantum information progresses through time as qubit registers and classical bit registers are operated on by various controls and gate operations. The visual interface disclosed herein enables programming of a quantum processor in a manner that intuitively reflects this progression of quantum information over time. In addition, a visual programming interface as disclosed herein provides immediate feedback to a user regarding what operations are allowed and what operations may not be allowed at various points in time based on what operations have been specified at earlier points in time. Moreover, the visual nature of the quantum circuit composer interface disclosed herein enhances a user's ability to learn and gain familiarity with quantum computing programming. Further, given the present day ubiquity of mobile devices, the user interface described herein can be accessed via smartphone and tablet interfaces and manipulated using touch-based gestures. It should be appreciated that the user interface can also be accessed and manipulated using cursor-based devices (e.g., a desktop or laptop computer).

As previously noted, the interactive user interface for composing quantum circuits can be implemented within a cloud-based environment. For example, the user interface may be stored on server that is accessible by a client device. The client device may communicate with the server over one or more networks, receive the user interface from the server, and display the user interface via a display of the client device. User interactions with and manipulations to the user interface may be processed by the server and reflected in the graphical representation of a quantum circuit displayed on the client device. It should be appreciated that in certain example embodiments, at least a portion of the interactive user interface may be stored on the client device and/or at least some of the processing to determine, based on user interactions with the interface, what should be rendered in the interface and how it should be rendered may be executed on the client device.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

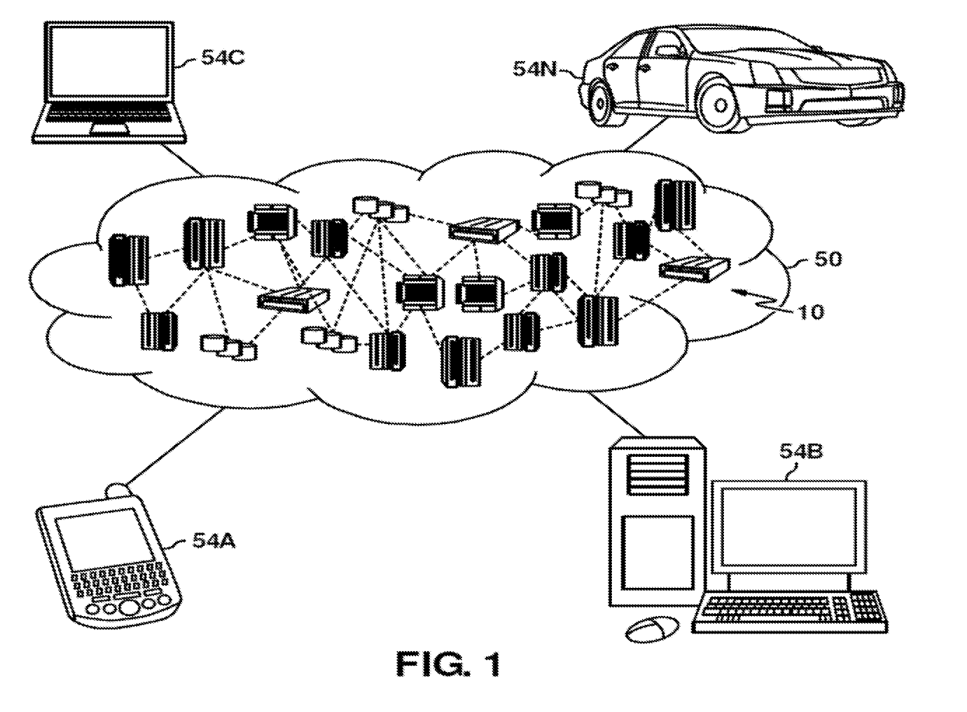

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

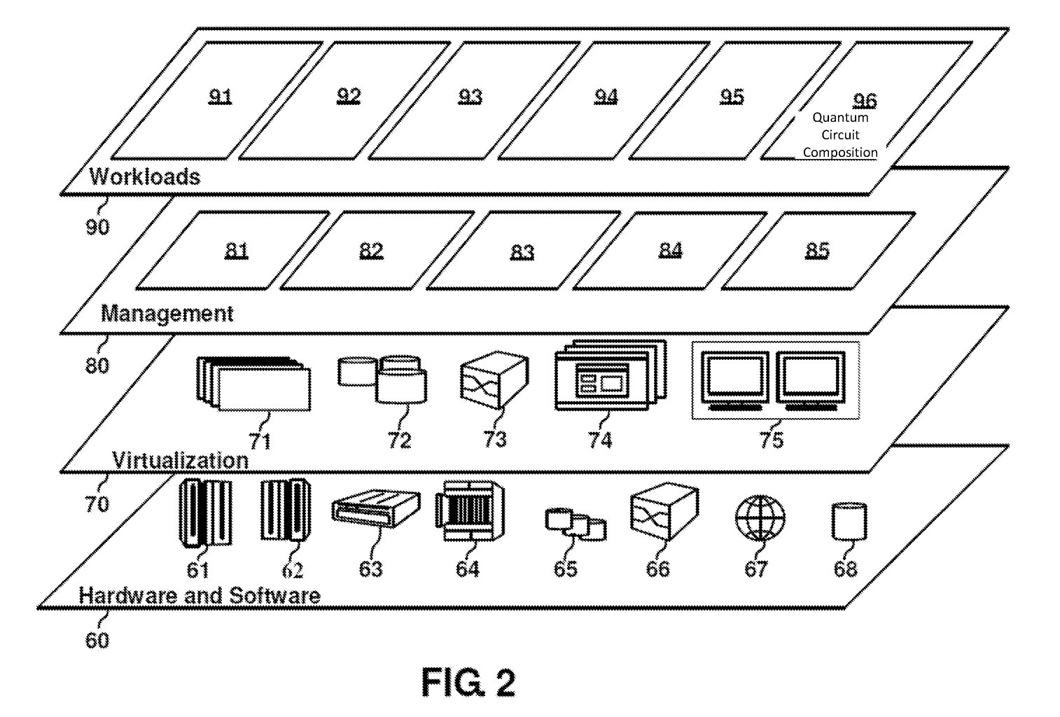

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and quantum circuit composition 96.

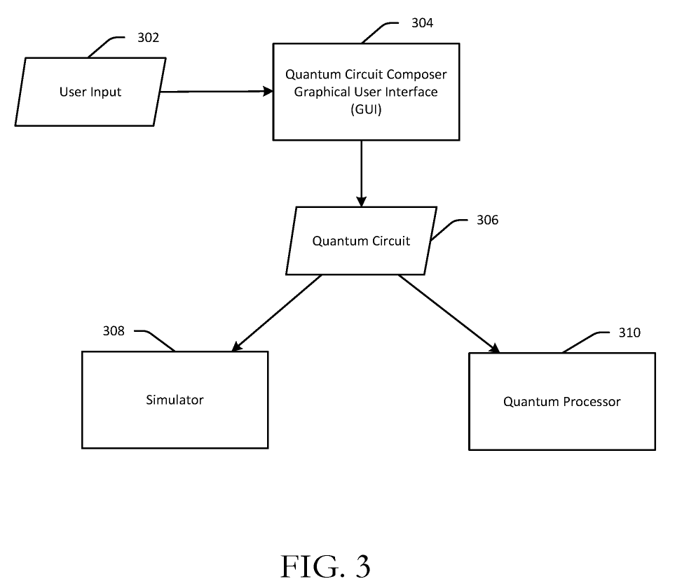

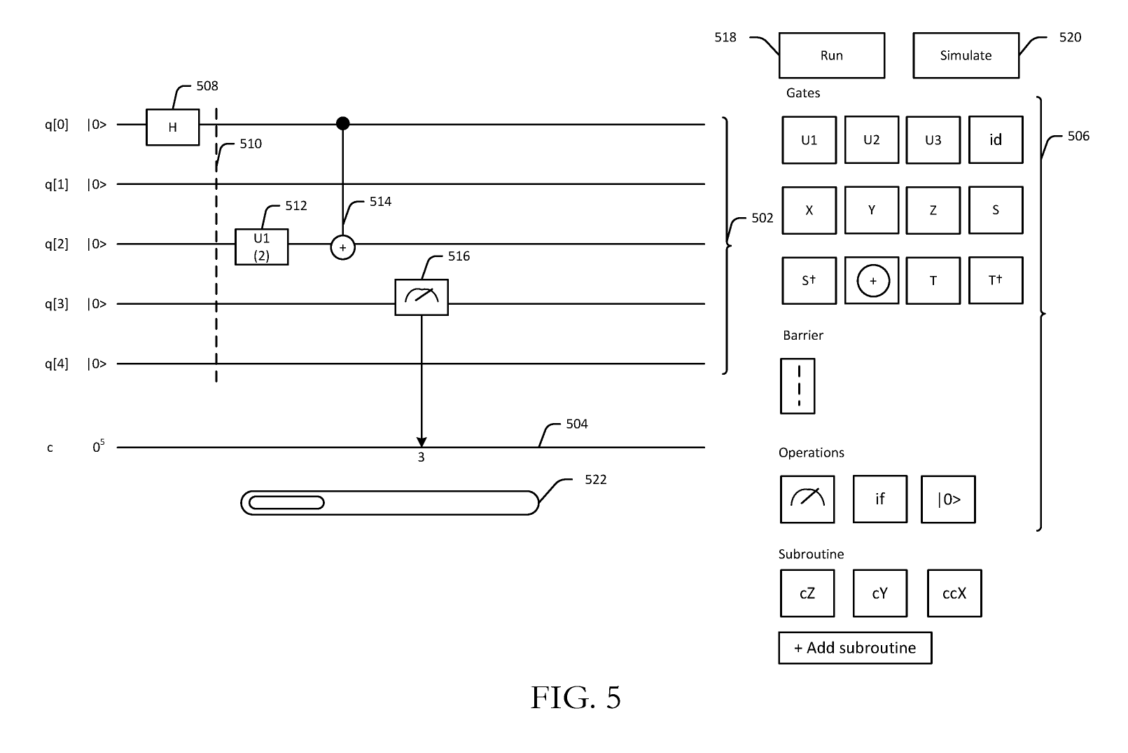

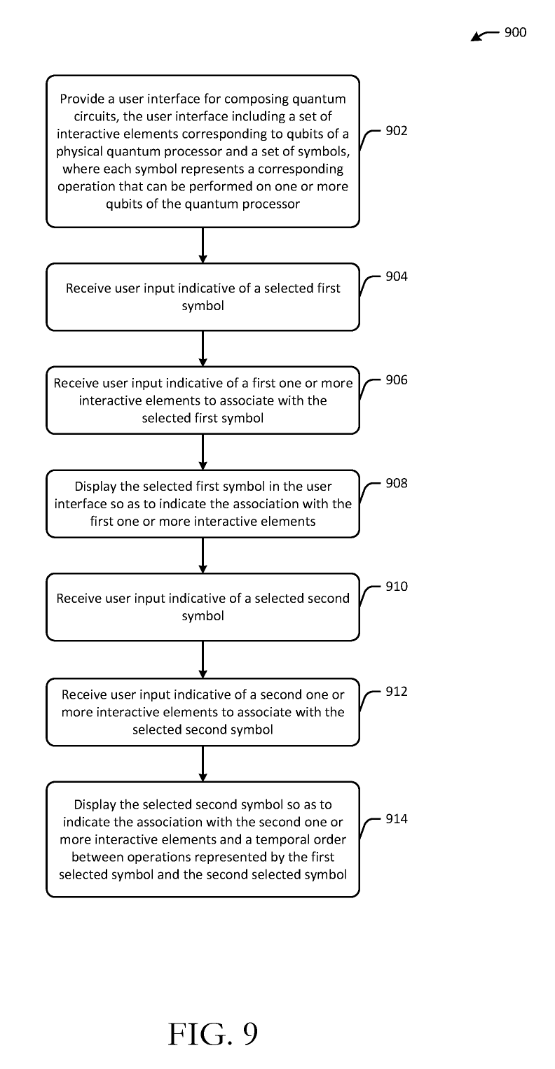

FIG. 3 is a schematic block diagram illustrating the composition of a quantum circuit using an interactive user interface. FIG. 5 depicts an example interactive user interface for composing quantum circuits. FIG. 9 is a process flow diagram of an illustrative method 900 for composing a quantum circuit using an interactive user interface. FIGS. 3, 5, and 9 will be described in conjunction with one another hereinafter.

One or more operations of any of the methods disclosed herein may be performed by one or more engines, or more specifically, by one or more program modules or sub-modules forming part of such engine(s). A module, which may contain or be a collection of one or more sub-modules, may include computer-executable instructions that when executed by a processing circuit may cause one or more operations to be performed. A processing circuit may include one or more processing units or nodes. Computer-executable instructions may include computer-executable program code that when executed by a processing unit may cause input data contained in or referenced by the computer-executable program code to be accessed and processed to yield output data. Any module described herein may be implemented in any combination of software, hardware, and/or firmware. Depending on the implementation, any module described herein may form part of a larger collection of modules that together may constitute an engine, an application, or the like.

Referring now to FIGS. 3, 5, and 9 in conjunction with one another, at block 902, a user interface (e.g., a quantum circuit composer GUI 304 depicted in FIG. 3) for composing quantum circuits may be provided. As previously noted, the GUI 304 may be stored at a remote server and sent to a requesting client device configured to display the GUI 304. An example implementation of the GUI 304 is depicted in FIG. 5. As shown, the GUI 304 may include a set of interactive elements 502, where each interactive element corresponds to a respective qubit of a qubit register of a physical quantum computer. For example, the interactive elements 502 may be a series of lines that represent the state of qubits over a progression of time. In certain example embodiments, each qubit may be initialized prior to composing a quantum circuit. This is depicted in FIG. 5 by the initialization vector |10> next to each interactive element.

In addition, an interactive element 504 corresponding to a classical bit register may also be rendered in the GUI 304. Through selection of the number of classical bits, a register of classical bits can provide computational bit space, where measurements from qubit operations can be passed to classical bits for bit-wise logical operations. The interactive element 504 may be rendered in a collapsed state where it represents all classical bits of a classical bit register together. For operations that act on bits of the classical bit register, the bit position on which an operation acts may be separately indicated when the interactive element 504 is in the collapsed state. In certain example embodiments, the interactive element 504 may be expanded to reveal multiple interactive elements (e.g., multiple horizontal lines), each of which corresponds to a respective bit in the classical bit register. Although FIG. 5 depicts a single qubit register containing 5 qubits (each represented by a corresponding interactive element 502) and a single classical bit register, it should be appreciated that multiple qubit registers and/or multiple classical bit registers may be represented in the GUI 304. For example, a second set of interactive elements may be rendered, where each interactive element in the second set represents a corresponding qubit in a second qubit register.

The GUI 304 may also include symbols 506 representative of various operations that may be performed on qubits and/or classical bits. The operations may include gate operations including single-qubit gate operations and multi-qubit gate operations. In certain example embodiments, single-qubit gate operations and measurement operations may be added to a quantum circuit via a drag-and-drop operation performed by a user using a mouse or by touch-based interactions on a touch-sensitive display on which the GUI 304 is presented. More specifically, a symbol representative of a single-qubit gate operation (e.g., the Hadamard operation) may be selected and placed on an interactive element 502 corresponding to a qubit on which the operation is desired to be performed. This may be achieved by a drag-and-drop user interaction with the GUI 304 using a mouse cursor or by performing a touch gesture such as a tap and drag on a touch-sensitive display. In certain example embodiments, the symbol may be permitted to be dropped only at a temporal node of the selected interactive element 502 that represents a point in time at which the underlying operation can be performed on the selected qubit.

Examples of canonical single-qubit quantum gates include the Hadamard gate operation (H); bit and phase flips (X, Y, Z); phase gates (S, S^{†}), t-gates (T, T^{†}), and the identity gate (or wait gate). Multi-gate qubit operations may include two-qubit gate operations such as the CNOT gate. The symbols 506 may also include symbols representative of parameterized gate operations (e.g., U1) for which one or more parameters must be specified. In certain example embodiments, responsive, at least in part, to user selection of a symbol representing a parameterized gate operation and association of the symbol with one or more interactive elements (e.g., placement of the symbol on an interactive element corresponding to a particular qubit), the server hosting the GUI 304 may query the user for one or more parameter values to associate with the parameterized operation. Further, the symbols 506 may include a symbol representing a conditional operation (e.g., the “if” symbol) that allows for classical control of a quantum gate operation, for example. The symbols 506 may also include a symbol representing an initialization operation (e.g., the “|0>” symbol) which can be used to re-initialize a qubit. In addition, in certain example embodiments, an advanced gate menu may be provided for selecting arbitrary single-qubit rotations that are parameterized by user input angles (e.g., 3 Euler angles specify an arbitrary single-qubit rotation).

The operations represented by the symbols 506 may further include a symbol representative of a barrier operation that can be used to create a temporal boundary between operations of a quantum circuit. For example, placement of the barrier symbol on the set of interactive elements 502 at a particular temporal node may cause a temporal separation between a first portion of the quantum circuit that includes operations performed prior to the barrier and a second portion of the quantum circuit that includes operations performed after the barrier. This temporal separation prevents concatenation of a first operation in the first portion with a second operation in the second portion during compilation.

In addition, the symbols 506 may include a symbol representative of a single-qubit measurement operation. The measurement operation measures a qubit state and stores the result as a classical bit result. As such, a measurement operation points a qubit in the qubit register to a classical bit in the classical bit register. This can be achieved by allowing the user to perform a drag-and-drop operation beginning at the interactive element corresponding to the qubit to be measured and ending at an interactive element representing a classical bit where the measured value is to be stored. Alternatively, the system may query the user to designate a classical bit for storing the result of the measurement operation. In either scenario, a graphical indication of the link between the qubit being measured and the classical bit storing the measurement result may be rendered in the GUI 304. For example, an arrow may be rendered that extends from the symbol representing the measurement operation (which is placed on an interactive element 502 corresponding to the qubit to be measured) to the interactive element 504 representing the classical bit register (in which case the particular bit position may be separately indicated as shown in FIG. 5) or to an interactive element representing the specific bit position if, for example, the interactive element 504 is expanded.

Referring again to FIG. 9, at block 904, user input 302 to the GUI 304 may be received. The user input 302 may be indicative of a first symbol 508 selected by a user from the set of symbols 506. For example, referring to the example quantum circuit shown in FIG. 5, the first symbol 508 may be representative of single-qubit Hadamard gate operation. At block 906, further user input 302 to the GUI 304 may be received that indicates a first one or more of the interactive elements 502 to associate with the selected first symbol 508. This further user input 302 received at block 906 may be received when a user clicks or taps on the first symbol 508 and drags it such that it hovers over a particular interactive element 502 (e.g., the interactive element 502 corresponding to qubit q[0]). Then, at block 908, the selected first symbol 508 may be displayed in the GUI 304 so as to indicate the association with the first one or more interactive elements 502. More specifically, when the user releases the mouse click or ceases touch interaction with the display, the symbol 508 may be rendered superimposed over the interactive element corresponding to qubit q[0] so as to indicate the association there between, as depicted in FIG. 5.

At block 910, further user input 302 indicative of a second selected symbol 512 may be received at the GUI 304. The second selected symbol 512 may be, for example, a parameterized gate operation (e.g., U1). At block 912, further user input 302 may be received at the GUI 304 that indicates a second one or more of the interactive elements 502 to associate with the selected second symbol 512. This further user input 302 received at block 912 may similarly be received when a user clicks or taps on the second symbol 512 and drags it such that it hovers over a particular interactive element 502 (e.g., the interactive element 502 corresponding to qubit q[2]). Then, at block 914, the selected second symbol 512 may be displayed in the GUI 304 so as to indicate the association with the second one or more interactive elements 502. More specifically, the symbol 512 may be rendered superimposed over the interactive element corresponding to qubit q[2] so as to indicate the association there between, as depicted in FIG. 5. In addition, because the selected second symbol 512 in this example represents a parameterized gate operation, the user may be prompted to specify parameter values in connection with the addition of the second symbol 512 to the quantum circuit being composed.

In addition, each of the selected symbols 508, 512 may be placed at temporal nodes of the respective interactive elements so as to indicate a temporal order between the operations represented by the symbols (e.g., the Hadamard operation and the parameterized gate operation). That is, placement of the symbols 508, 512 within the GUI 304 may graphically indicate the sequential performance of the operations on the corresponding selected qubits. In certain example embodiments, a barrier symbol 510 may be placed between the symbols 508 and 512 to indicate a temporal boundary between the underlying operations of symbols 508, 512. As previously described, the barrier may prevent undesired concatenation of the operation represented by the symbol 508 with the operation represented by the symbol 512. In certain example embodiments, in the absence of the barrier represented by the symbol 510, there is a possibility that the operations represented by symbols 508 and 512 are performed on their respective qubits at least partially concurrently.

The quantum circuit may continue to be composed in the manner described above with additional symbols being selected and placed onto interactive elements that correspond to qubits on which operations represented by the additional symbols are to be performed. For example, a symbol 514 representing a CNOT operation is depicted in FIG. 5 as being placed subsequent to the symbol 512, and a symbol 516 representing the measurement operation is depicted as being placed subsequent to the symbol 514. The mechanism for adding the measurement operation to the quantum circuit has been described earlier. The mechanism for adding the CNOT operation to the quantum circuit will be described in more detail later in this disclosure. In certain example embodiments, a grid may be present in the GUI 304 to ensure appropriate spacing of symbols within the graphical representation of the quantum circuit being formed. For example, a symbol may not be permitted to be placed within a threshold number of grid units of an adjacent symbol in order to ensure sufficient spacing. Insufficient spacing between symbols may reduce comprehensibility of the quantum circuit to a user. The grid may or may not be visible to a user.

As additional symbols are superimposed on the interactive elements 502, a point may be reached where further segments of the interactive elements 502 that are available for placement of symbols are not displayed. As such, the GUI 304 may include a scroll bar 522 or the like that enables a user to scroll along the interactive elements 502 to expose additional segments that are available for placement of symbols. In addition, in example embodiments, symbols that have already been placed within the graphical representation of the quantum circuit can be double-clicked or double-tapped to be removed from the graphical representation, thereby removing the underlying operations they represent from the quantum circuit. Moreover, symbols that are single-tapped and held or clicked and held can be moved to other temporal points for the same qubit or onto different qubits.

Once all desired symbols have been placed and a corresponding completed quantum circuit 306 is obtained, the quantum circuit 306 may be executed on a simulator 308 and/or on a physical quantum processor 310. A selectable element 518 and a selectable element 520 may be included in the GUI 304. Selection of element 520 may cause a simulation of the quantum circuit 306 to be executed on the simulator 308. Similarly, selection of element 518 may cause the quantum circuit 306 to be executed on the physical quantum processor 310. It should be appreciated that the quantum processor 310 may be located remotely from the client device accessing the GUI 304. The simulator 308 may reside on the client device and/or a remote server. In addition, in certain example embodiments, once the visual composed quantum circuit 306 is generated, an auxiliary text-based script may also be created for reference.

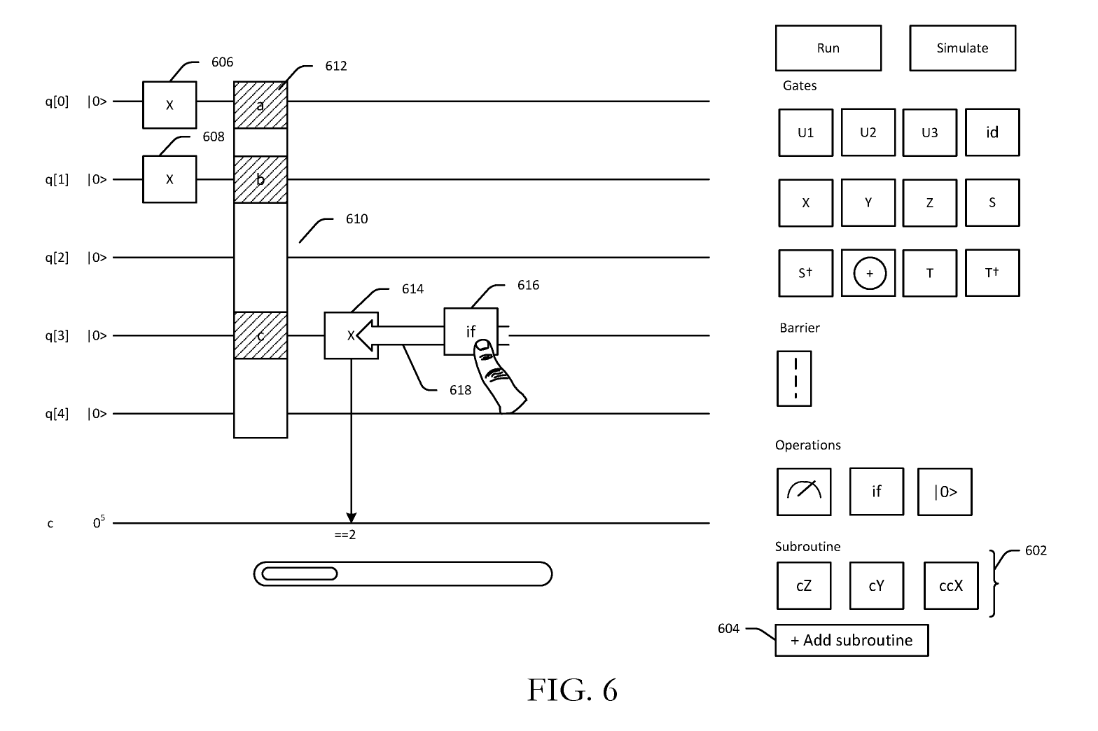

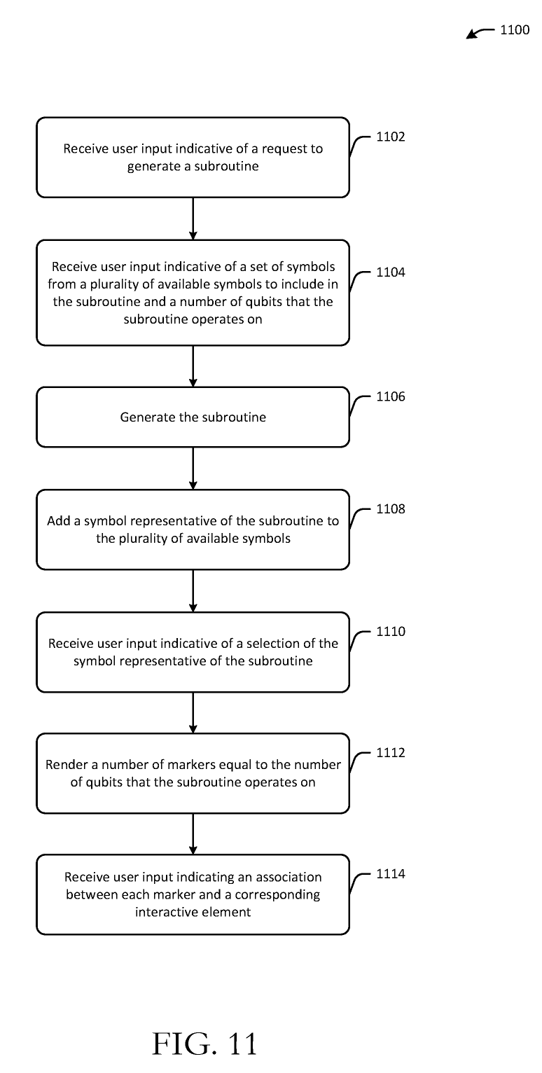

FIG. 6 depicts an example quantum circuit that includes a subroutine and classical control of a quantum operation in accordance with one or more example embodiments of the disclosure. FIG. 11 is a process flow diagram of an illustrative method 1100 for generating and adding a subroutine to a quantum circuit composed using an interactive user interface. FIGS. 6 and 11 will be described in conjunction with one another hereinafter.

Referring first to FIG. 11, at block 1102, user input indicative of a request to generate a subroutine may be received at the GUI 304. Referring now to FIG. 6, the GUI 304 may further include a set of symbols 602 corresponding to subroutines previously generated and stored for re-use. The GUI 304 may also include a selectable element 604 for adding a new subroutine. The user input received at block 1102 may be generated responsive to user selection of the selectable element 604. Subroutines may include multiple gates combined into a particular grouping that can be applied to any number of qubits in the qubit register.

At block 1104, further user input may be received at the GUI 304. This further user input may be indicative of a set of selected symbols from the set of available symbols 506 to include in the subroutine and a number of qubits that the subroutine operates on. At block 1106, the subroutine may be generated based on the user input, and at block 1108, a new symbol representing the generated subroutine may be added to the set of symbols 602.

At block 1110, user input may be received at the GUI 304 that is indicative of a selection of the symbol representing the subroutine generated at block 1106. Responsive to selection of this symbol, an object 610 representing the selected subroutine and spanning all interactive elements 502 may be rendered in the GUI 304. The object 610 may include a number of markers (e.g., marker 612) equaling the number of qubits that the subroutine operates on. The markers may be rendered at block 1112. The markers may be selectable and movable to any of the linear interactive elements 502 to indicate the particular set of qubits that the user wishes to execute the subroutine on.

More specifically, at block 1114, user input may be received at the GUI 304 indicating an association between each marker and a corresponding interactive element 502. In the example shown in FIG. 6, marker “a” 612 is associated with the interactive element corresponding to qubit q[0], marker “b” is associated with the interactive element corresponding to qubit q[1], and marker “c” is associated with the interactive element corresponding to qubit q[3]. The markers may be movable to different interactive elements 502 to designate different qubits for execution of the subroutine. For example, marker “b” can be moved and instead placed over the interactive element corresponding to qubit q[2] or the interactive element corresponding to qubit q[4]. The positions of two markers can also be reversed simply by dragging one marker to where another marker is currently placed and hovering there for a period of time.

FIG. 6 also depicts the application of a conditional operation to a quantum gate operation. As depicted, a symbol 614 representing a single-qubit gate operation, for example, may be added to the quantum circuit subsequent to addition of the subroutine as described above. A symbol 616 representing a conditional operation may then be selected and dragged 618 to the current location of the symbol 614. This indicates that classical control of the quantum operation represented by the symbol 614 is desired. A condition for satisfying the conditional operation represented by the symbol 616 may also be specified (e.g., that the value of the operation represented by symbol 614 is equal to 2). In addition, multiple single-qubit operations operating on different qubits (represented by symbols 606, 608) may be executed on their qubits at least partially concurrently because there is no barrier between the symbols 606, 608.

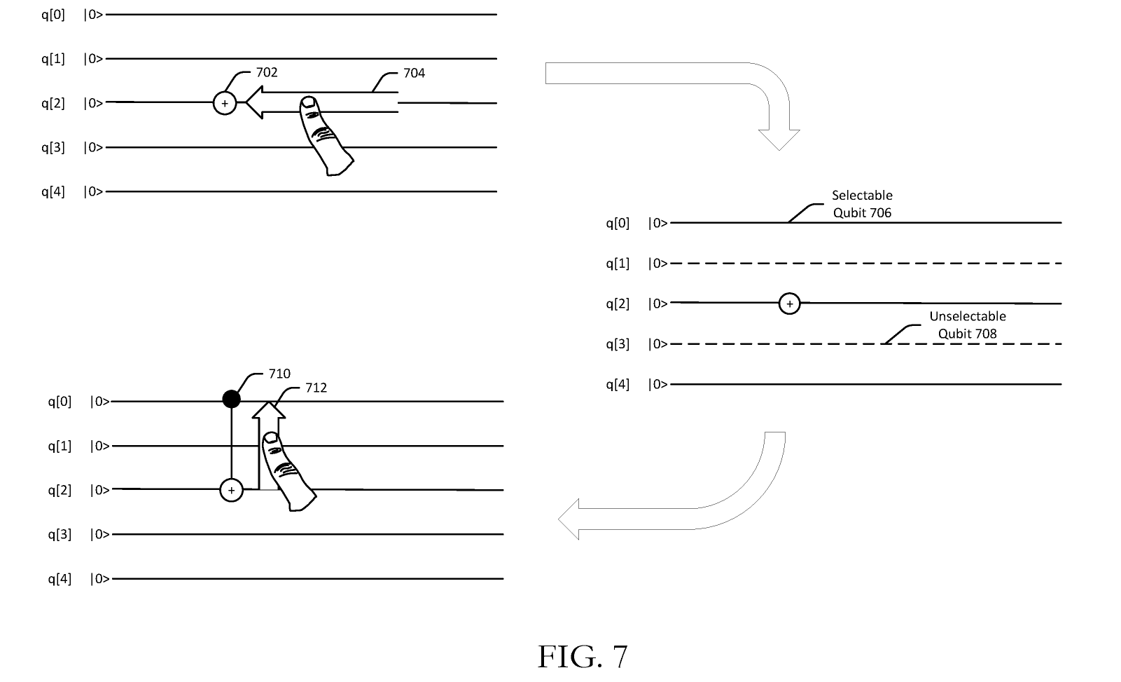

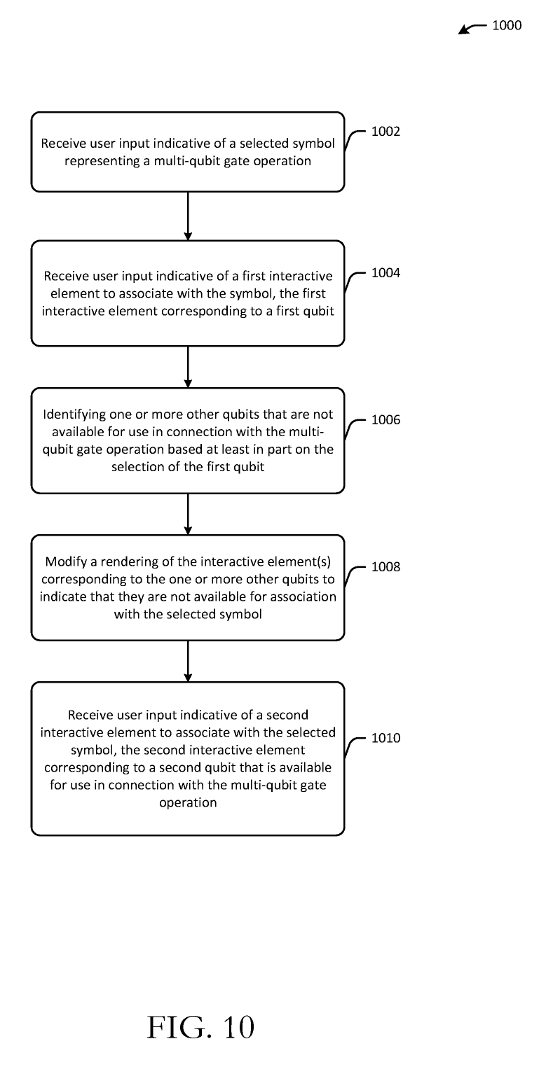

FIG. 7 depicts user interactions with the interactive user interface to produce a CNOT gate operation. FIG. 10 is a process flow diagram of an illustrative method 1000 for modifying an interactive user interface in response to selection of a multi-qubit gate operation to indicate qubit(s) that are unavailable for selection for the multi-qubit gate operation. FIGS. 7 and 10 will be described in conjunction with one another hereinafter.

At block 1002, user input may be received at the GUI 304 that is indicative of a selected symbol 702 representing a multi-qubit gate operation. As illustratively depicted in FIG. 7, the multi-qubit gate operation may be a CNOT operation. At block 1004, further user input may be received at the GUI 304 that is indicative of a first interactive element to associate with the selected symbol 702. The further user input may be in the form of a drag operation 704 of the selected symbol 702 to the first interactive element. In the example shown in FIG. 7, the first interactive element may correspond to a qubit (e.g., q[2]) that is selected by the user as the target qubit for the CNOT operation.

At block 1006, one or more other qubits in the qubit register that are not available for use in connection with the multi-qubit gate operation may be identified based at least in part on the selection of the first qubit. In the example of the CNOT operation depicted in FIG. 7, based on the selection of qubit q[2] as the target qubit for the CNOT operation, certain qubits may not be available for selection as the control qubit. Any such unavailable qubits may be identified.

For instance, assume that (q[0], q[2]); (q[4], q[2]); (q[1], q[0]); (q[2], q[1]); (q[2], q[3]); (q[3], q[4]) represent acceptable pairings of control and target qubits for the CNOT operation, where the control qubit is written first, followed by the target qubit. Referring to the example depicted in FIG. 7, based on the acceptable control and target qubit pairings given above, selection of qubit q[2] as the target qubit, would only leave qubits q[0] and q[4] as available for selection as the control qubit. Qubits q[1] and q[3] would not be available for selection as the control qubit because there are no acceptable pairings that includes qubit q[1] or qubit q[3] as the control qubit and qubit q[2] as the target qubit. It should be appreciated that in alternative example embodiments, the control qubit may be selected first, in which case, any qubit not included as a potential target qubit in a control-target pairing for the CNOT operation may be unavailable for selection as the target qubit.

Then, at block 1008, a rendering of the interactive element(s) corresponding to the one or more unavailable qubits may be modified to indicate that those qubit(s) are unavailable for selection based on the selection of the first qubit. Thus, as shown in FIG. 7, if it is determined that qubits q[1] and q[3] are not selectable as the control qubit for the CNOT operation based on the selection of qubit q[2] as the target qubit, the interactive elements in the GUI 304 that correspond to qubits q[1] and q[3] may be re-rendered with indicia that indicates that they are not selectable in connection with the CNOT operation. Interactive elements corresponding to unselectable qubits are illustratively depicted in FIG. 7 using dashed lines. For example, the interactive element corresponding to qubit q[3] is rendered (e.g., as a dashed line) to indicate that qubit q[3] is an unselectable qubit 708 for the CNOT operation based on the selection of qubit q[2] as the target qubit. Interactive elements corresponding to qubits that are available for selection as the control qubit (e.g., the interactive element corresponding to selectable qubit q[0] 706) may remain unchanged, and thus, may be distinguished from those interactive elements associated with unselectable qubits. In one or more example embodiments, the rendering of interactive elements corresponding to selectable qubits may be modified in addition to, or in lieu of, modifying the interactive elements corresponding to unselectable qubits in order to distinguish selectable qubits from the unselectable qubits.

At block 1010, additional user input may be received at the GUI 304 that is indicative of a second interactive element to associate with the selected symbol 702. The second interactive element may correspond to a second qubit that is available for use in connection with the multi-qubit gate operation. In the example depicted in FIG. 7, qubit q[0] is illustratively shown as being selected as the control qubit. The user may indicate the selection of q[0] as the control qubit by performing a drag operation 712 from the location of the symbol 702 to the interactive element corresponding to the qubit selected as the target qubit. Qubit q[0] may be indicated as the selected control qubit by rendering indicia 710 on the interactive element corresponding to qubit q[0]. The indicia 710 may be rendered to have a different appearance than the symbol 702 in order to distinguish the control qubit from the target qubit for the CNOT operation. A line connecting the interactive element corresponding to the selected target qubit and the interactive element corresponding to the selected control qubit may also be rendered to illustrate which qubits have been selected for the CNOT.

The entire CNOT operation (or any two-qubit operation) may be implemented in a mouse interface, for example, by clicking on the selected symbol 702 and dragging the symbol 702 to an interactive element that corresponds to the qubit that is desired as the target qubit, and then releasing and performing a drag operation from the location of the symbol 702 to the interactive element corresponding to the desired control qubit. In touch interfaces, a two-qubit gate operation may be specified by dragging the selected symbol 702 to an interactive element corresponding to the desired target qubit, performing a double tap touch gesture, performing a drag operation from the location of the symbol 702 to the interactive element corresponding to the desired control qubit, and performing another double tap touch gesture. It should be appreciated that the example implementations for creating graphical representations of multi-qubit gate operations described above are merely illustrative and not exhaustive.

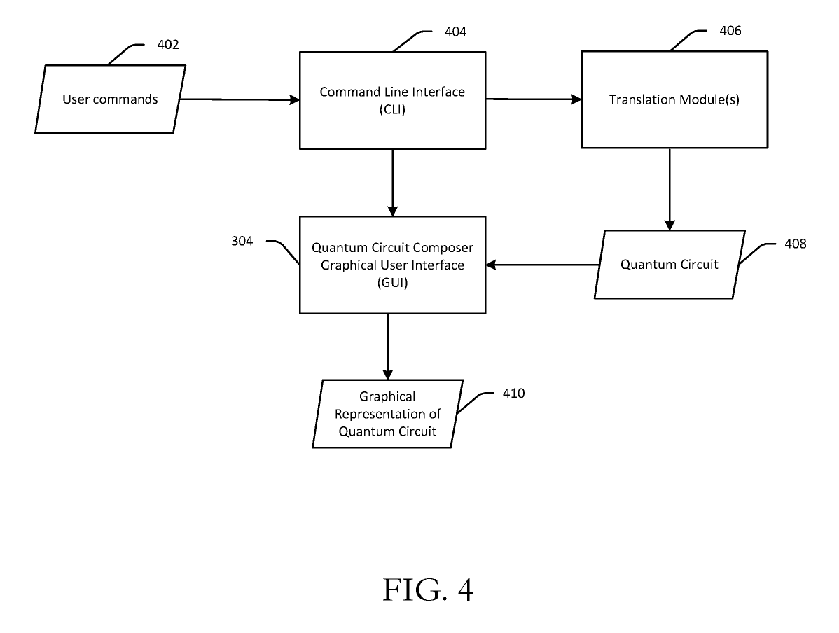

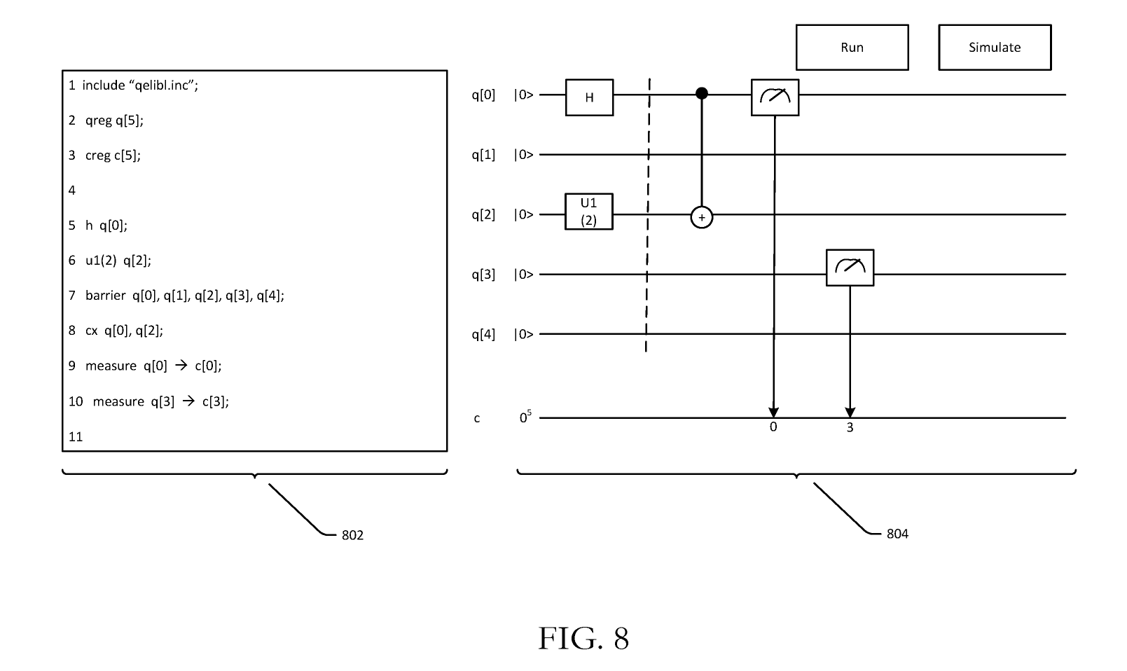

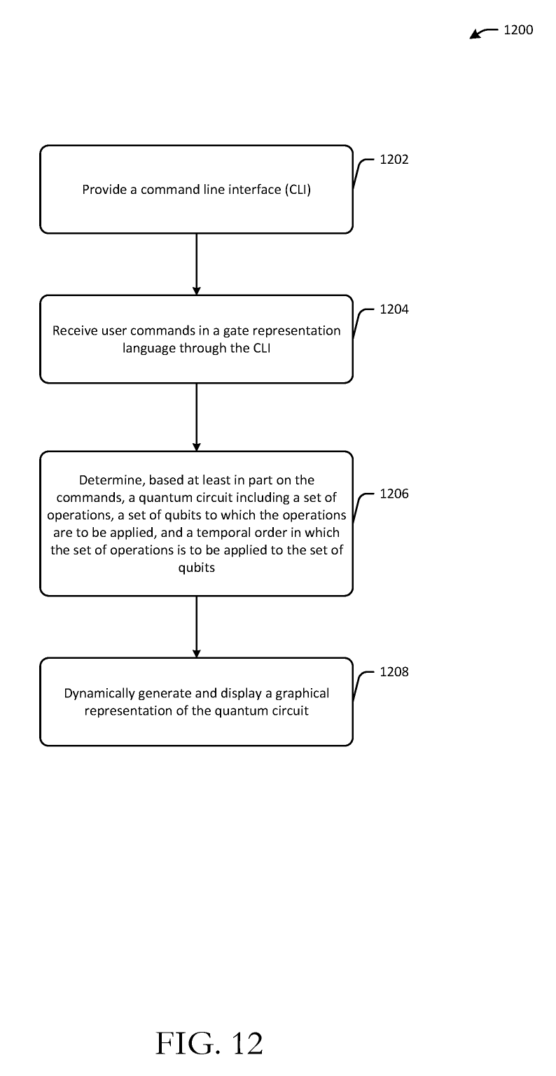

FIG. 4 is a schematic block diagram illustrating the dynamic generation of a graphical representation of a quantum circuit based on user commands in a gate representation language. FIG. 8 depicts dynamic generation of a graphical representation of a quantum circuit responsive to user commands entered via a CLI. FIG. 12 is a process flow diagram of an illustrative method 1200 for dynamically generating a graphical representation of a quantum circuit responsive to user commands entered via a CLI in accordance with one or more example embodiments of the disclosure. FIGS. 4, 8, and 12 will be described in conjunction with one another hereinafter.

At block 1202, a command line interface (CLI) 404 may be provided. The CLI 404 may be provided in association with a set of interactive elements representing qubits and/or classical bits/bit registers, as depicted in FIG. 8. At block 1204, user commands 402 written in a gate representation language such as quantum assembly language (QASM) may be received via the text-entry interface of the CLI 404.

At block 1206, computer-executable instructions of one or more translation modules 1318 may be executed to determine, based at least in part on the user commands 402, a quantum circuit 408 including a set of operations, a set of qubits to which the operations are to be applied, and a temporal order in which the set of operations is to be performed on the set of qubits. Then, at block 1208, a graphical representation 410 of the quantum circuit 408 may be presented via the GUI 304. For example, as shown in FIG. 8, the set of commands 802 may be translated by the translation module(s) 406 to determine the quantum circuit 408 represented by the set of commands 802, and a graphical representation 804 of the quantum circuit 408 represented by the set of commands 802 may be displayed within the GUI 304. Further, in example embodiments, modifications to the set of commands 802 may cause the graphical representation to dynamically change to reflect the updated quantum circuit represented by the modified set of commands 802.

Example embodiments of the disclosure provide various technical features, technical effects, and/or improvements to computer technology. For instance, example embodiments of the disclosure provide the technical effect of facilitating the composition of quantum circuits using an efficient and user-friendly mechanism such that execution of the quantum circuit, once composed, can be simulated or performed on an actual physical quantum processor. This technical effect is achieved at least in part by providing an interactive graphical user interface capable of being manipulated via user interactions to compose and graphically represent a quantum circuit in an intuitive manner that clearly identifies the sequence of operations of the quantum circuit over time and the qubits and/or classical bits on which they operate. The above-described technical features and their corresponding technical effect yield an improvement to quantum computing by providing a more efficient and intuitive mechanism for composing and representing quantum circuits.

One or more illustrative embodiments of the disclosure are described herein. Such embodiments are merely illustrative of the scope of this disclosure and are not intended to be limiting in any way. Accordingly, variations, modifications, and equivalents of embodiments disclosed herein are also within the scope of this disclosure.

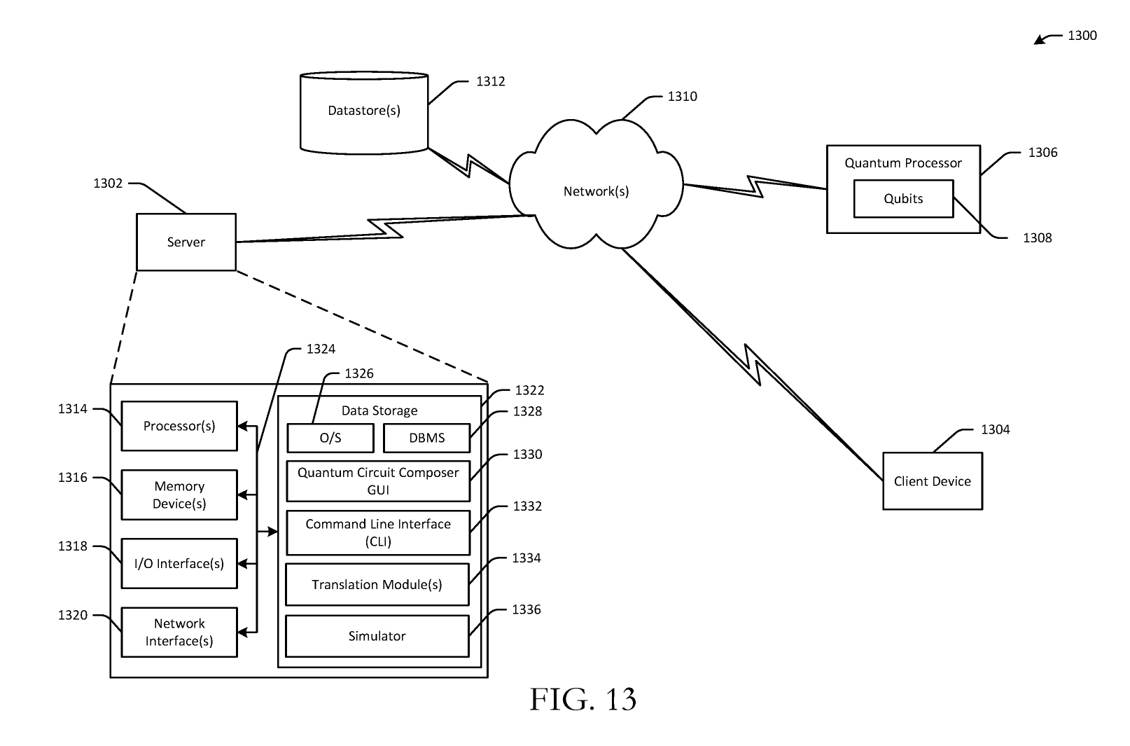

FIG. 13 is a schematic diagram of an illustrative networked architecture 1300 in accordance with one or more example embodiments of the disclosure. The networked architecture 1300 may include one or more servers 1302, one or more client devices 1304, a quantum processor 1306, and one or more datastores 1312. While multiple instances of each of the components depicted may be present in the networked architecture 1300, these components will be described in the singular hereinafter for ease of explanation. However, it should be appreciated that any functionality described in connection with the server 1302 may be distributed among multiple servers 1302 and/or among one or more client devices 1304.

The server 1302 may be configured to communicate with the client device 1304 and the quantum processor 1306 and may access the datastore(s) 1312 via one or more networks 1310 which may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, the network(s) 1310 may have any suitable communication range associated therewith and may include, for example, global networks (e.g., the Internet), metropolitan area networks (MANs), wide area networks (WANs), local area networks (LANs), or personal area networks (PANs). In addition, the network(s) 1310 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof

In an illustrative configuration, the server 1302 may include one or more processors (processor(s)) 1314, one or more memory devices 1316 (generically referred to herein as memory 1316), one or more input/output (“I/O”) interface(s) 1318, one or more network interfaces 1320, and data storage 1322. The server 1302 may further include one or more buses 1324 that functionally couple various components of the server 1302.

The bus(es) 1324 may include at least one of a system bus, a memory bus, an address bus, or a message bus, and may permit exchange of information (e.g., data (including computer-executable code), signaling, etc.) between various components of the computing device 800. The bus(es) 1324 may include, without limitation, a memory bus or a memory controller, a peripheral bus, an accelerated graphics port, and so forth. The bus(es) 1324 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 1316 of the server 1302 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 1316 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 1316 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 1322 may include removable storage and/or non-removable storage including, but not limited to, magnetic storage, optical disk storage, and/or tape storage. The data storage 1322 may provide non-volatile storage of computer-executable instructions and other data. The memory 1316 and the data storage 1322, removable and/or non-removable, are examples of computer-readable storage media (CRSM) as that term is used herein.

The data storage 1322 may store computer-executable code, instructions, or the like that may be loadable into the memory 1316 and executable by the processor(s) 1314 to cause the processor(s) 1314 to perform or initiate various operations. The data storage 1322 may additionally store data that may be copied to memory 1316 for use by the processor(s) 1314 during the execution of the computer-executable instructions. Moreover, output data generated as a result of execution of the computer-executable instructions by the processor(s) 1314 may be stored initially in memory 1316 and may ultimately be copied to data storage 1322 for non-volatile storage.

More specifically, the data storage 1322 may store one or more operating systems (O/S) 1326; one or more database management systems (DBMS) 1328 configured to access the memory 1316 and/or one or more external data repositories (e.g., the datastore(s) 1312); and one or more program modules, applications, engines, computer-executable code, scripts, or the like such as, for example, a quantum circuit composer GUI 1330, a command line interface (CLI) 1332, one or more translation modules 1334, and a simulator 1336. Any of the components depicted as being stored in data storage 1322 may include any combination of software, firmware, and/or hardware. The software and/or firmware may include computer-executable instructions (e.g., computer-executable program code) that may be loaded into the memory 1316 for execution by one or more of the processor(s) 1314 to perform any of the operations described earlier in connection with correspondingly named components. As described throughout this disclosure, a quantum circuit may be composed using the GUI 1330, which may be accessible on the client device 1304. Further, a composed quantum circuit may be executed on the quantum processor 1306. More specifically, the various operations of the composed quantum circuit may operate on qubits 1308 of the quantum processor 1306.

Although not depicted in FIG. 13, the data storage 1322 may further store various types of data utilized by components of the server 1302 (e.g., quantum circuit data, mappings between symbols and corresponding operations, mappings between interactive elements in the GUI 1330 and corresponding qubits, etc.). Any data stored in the data storage 1322 may be loaded into the memory 1316 for use by the processor(s) 1314 in executing computer-executable instructions. In addition, any data stored in the data storage 1322 may potentially be stored in one or more of the datastore(s) 1312 and may be accessed via the DBMS 1328 and loaded in the memory 1316 for use by the processor(s) 1314 in executing computer-executable instructions.

The processor(s) 1314 may be configured to access the memory 1316 and execute computer-executable instructions loaded therein. For example, the processor(s) 1314 may be configured to execute computer-executable instructions of the various program modules, applications, engines, or the like of the server 1302 to cause or facilitate various operations to be performed in accordance with one or more embodiments of the disclosure. The processor(s) 1314 may include any suitable processing unit capable of accepting data as input, processing the input data in accordance with stored computer-executable instructions, and generating output data. The processor(s) 1314 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a

Field-Programmable Gate Array (FPGA), a System-on-a-Chip (SoC), a digital signal processor (DSP), and so forth. Further, the processor(s) 1314 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 1314 may be capable of supporting any of a variety of instruction sets.

Referring now to other illustrative components depicted as being stored in the data storage 1322, the O/S 1326 may be loaded from the data storage 1322 into the memory 1316 and may provide an interface between other application software executing on the server 1302 and hardware resources of the server 1302. More specifically, the O/S 1326 may include a set of computer-executable instructions for managing hardware resources of the server 1302 and for providing common services to other application programs (e.g., managing memory allocation among various application programs). In certain example embodiments, the O/S 1326 may control execution of one or more of the program modules depicted as being stored in the data storage 1322. The O/S 1326 may include any operating system now known or which may be developed in the future including, but not limited to, any server operating system, any mainframe operating system, or any other proprietary or non-proprietary operating system.

The DBMS 1328 may be loaded into the memory 1316 and may support functionality for accessing, retrieving, storing, and/or manipulating data stored in the memory 1316, data stored in the data storage 1322, and/or data stored in the data repositories 444. The DBMS 1328 may use any of a variety of database models (e.g., relational model, object model, etc.) and may support any of a variety of query languages. The DBMS 1328 may access data represented in one or more data schemas and stored in any suitable data repository. The datastore(s) 1312 may be accessible by the server 1302 via the DBMS 1328 may include, but are not limited to, databases (e.g., relational, object-oriented, etc.), file systems, flat files, distributed datastores in which data is stored on more than one node of a computer network, peer-to-peer network datastores, or the like. It should be appreciated that, in certain example embodiments, any of the datastore(s) 1312 and/or any of the data residing thereon may additionally, or alternatively, be stored locally in the data storage 1322. The datastore(s) 1312 may store any data applicable to example embodiments of the disclosure including any of the example types of data described as potentially being stored in the data storage 1322.

Referring now to other illustrative components of the server 1302, the input/output (I/O) interface(s) 1318 may facilitate the receipt of input information by the server 1302 from one or more I/O devices as well as the output of information from the server 1302 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the server 1302 or may be separate. The I/O devices may further include, for example, any number of peripheral devices such as data storage devices, printing devices, and so forth.

The I/O interface(s) 1318 may also include an interface for an external peripheral device connection such as universal serial bus (USB), FireWire, Thunderbolt, Ethernet port or other connection protocol that may connect to one or more networks. The I/O interface(s) 1318 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The server 1302 may further include one or more network interfaces 1320 via which the server 1302 may communicate with any of a variety of other systems, platforms, networks, devices, and so forth. The network interface(s) 1320 may enable communication, for example, with one or more other devices via one or more of the networks 1310.

It should be appreciated that the program modules depicted in FIG. 13 as being stored in the data storage 1322 are merely illustrative and not exhaustive and that processing described as being supported by any particular module may alternatively be distributed across multiple modules, or the like, or performed by a different module or the like. In addition, various program module(s), script(s), plug-in(s), Application Programming Interface(s) (API(s)), or any other suitable computer-executable code hosted locally on the server 1302 and/or hosted on other computing device(s) accessible via one or more of the network(s) 1310, may be provided to support functionality provided by the modules depicted in FIG. 13 and/or additional or alternate functionality. Further, functionality may be modularized differently such that processing described as being supported collectively by a collection of modules depicted in FIG. 13 may be performed by a fewer or greater number of program modules, or functionality described as being supported by any particular module may be supported, at least in part, by another program module. In addition, program modules that support the functionality described herein may form part of one or more applications executable across any number of servers 1302 and/or client devices 1304 in accordance with any suitable computing model such as, for example, a client-server model, a peer-to-peer model, and so forth. In addition, any of the functionality described as being supported by any of the program modules depicted in FIG. 13 may be implemented, at least partially, in hardware and/or firmware across any number of devices.

It should further be appreciated that the server 1302 may include alternate and/or additional hardware, software, or firmware components beyond those described or depicted without departing from the scope of the disclosure. More particularly, it should be appreciated that software, firmware, or hardware components depicted as forming part of the server 1302 are merely illustrative and that some components may not be present or additional components may be provided in various embodiments. While various illustrative program modules have been depicted and described as software modules stored in data storage 1322, it should be appreciated that functionality described as being supported by the engines or modules may be enabled by any combination of hardware, software, and/or firmware. It should further be appreciated that each of the above-mentioned engines or modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted or described as sub-modules of another module, in certain embodiments, such modules may be provided as independent modules or as sub-modules of other modules.

One or more operations of the any of the methods disclosed herein may be performed by a server 1302 having the illustrative configuration depicted in FIG. 13, or more specifically, by one or more program modules, engines, applications, or the like executable on such a device. It should be appreciated, however, that such operations may be implemented in connection with numerous other device configurations.

The operations described and depicted in the illustrative methods of FIGS. 9-12 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 9-12 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular system, system component, device, or device component may be performed by any other system, device, or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like may be additionally based on one or more other operations, elements, components, data, or the like. Accordingly, the phrase “based on,” or variants thereof, should be interpreted as “based at least in part on.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for composing a quantum circuit, the method comprising:
providing a user interface comprising:
a set of interactive elements corresponding to qubits of a physical quantum processor, wherein each interactive element represents a progression of quantum information over time in a respective qubit; and
a set of symbols, wherein each symbol is representative of a corresponding operation capable of being performed on one or more of the qubits;
receiving user input indicative of: i) one or more symbols selected from the set of symbols, ii) a corresponding one or more interactive elements with which the one or more symbols are associated, and iii) a temporal order in which the one or more symbols are associated with the one or more interactive elements; and
composing the quantum circuit based at least in part on the user input, wherein composing the quantum circuit comprises generating and displaying a graphical representation of the quantum circuit that includes the one or more symbols rendered in association with the one or more interactive elements in accordance with the temporal order.

2. The computer-implemented method of claim 1, further comprising executing a simulation of the quantum circuit.

3. The computer-implemented method of claim 1, further comprising executing the quantum circuit on the physical quantum processor.

4. The computer-implemented method of claim 1, wherein the one or more selected symbols includes a particular symbol representative of a multi-qubit gate operation, and wherein receiving the user input comprises receiving a selection of a first interactive element corresponding to a first qubit for the multi-qubit gate operation and a selection of a second interactive element corresponding to a second qubit for the multi-qubit gate operation, the method further comprising:
determining that a particular qubit is unavailable for selection as the second qubit based at least in part on the selected first qubit; and
modifying a third interactive element in the user interface to make the third interactive element unselectable, wherein the third interactive element corresponds to the particular qubit.

5. The computer-implemented method of claim 1, wherein the user interface further comprises an interactive element corresponding to a classical bit register, and wherein the one or more selected symbols comprises a particular symbol representative of a measurement operation, the method further comprising receiving a selection of a bit in the classical bit register in which a measurement value of the measurement operation is to be stored.

6. The computer-implemented method of claim 1, wherein the one or more selected symbols comprises a plurality of selected symbols and the user input is first user input, the method further comprising:
receiving second user input indicative of a request to generate a subroutine;
receiving third user input indicative of a set of the plurality of selected symbols to include in the subroutine and a number of qubits that the subroutine operates on;
generating the subroutine; and
adding a symbol representative of the subroutine to the set of symbols in the user interface to enable selection of the symbol and inclusion of the subroutine in the quantum circuit.

7. The computer-implemented method of claim 6, the method further comprising:
receiving fourth user input indicative of selection of the symbol representative of the subroutine;
rendering, in the user interface, a number of markers equal to the number of qubits that the subroutine operates on; and
receiving fifth user input indicating an association between each marker and a corresponding interactive element of the set of interactive elements.

8. A system for composing a quantum circuit, the system comprising:
at least one memory storing computer-executable instructions; and
at least one processor configured to access the at least one memory and execute the computer-executable instructions to:
provide a user interface comprising:
a set of interactive elements corresponding to qubits of a physical quantum processor, wherein each interactive element represents a progression of quantum information over time in a respective qubit; and
a set of symbols, wherein each symbol is representative of a corresponding operation capable of being performed on one or more of the qubits;
receive user input indicative of: i) one or more symbols selected from the set of symbols, ii) a corresponding one or more interactive elements with which the one or more symbols are associated, and iii) a temporal order in which the one or more symbols are associated with the one or more interactive elements; and
compose the quantum circuit based at least in part on the user input, wherein composing the quantum circuit comprises generating and displaying a graphical representation of the quantum circuit that includes the one or more symbols rendered in association with the one or more interactive elements in accordance with the temporal order.

9. The system of claim 8, wherein the one or more selected symbols includes a particular symbol representative of a multi-qubit gate operation, wherein receiving the user input comprises receiving a selection of a first interactive element corresponding to a first qubit for the multi-qubit gate operation and a selection of a second interactive element corresponding to a second qubit for the multi-qubit gate operation , and wherein the at least one processor is further configured to execute the computer-executable instructions to:
determine that a particular qubit is unavailable for selection as the second qubit based at least in part on the selected first qubit; and
modify a third interactive element in the user interface to make the third interactive element unselectable, wherein the third interactive element corresponds to the particular qubit.

10. The system of claim 8, wherein the user interface further comprises an interactive element corresponding to a classical bit register, wherein the one or more selected symbols comprises a particular symbol representative of a measurement operation, and wherein the at least one processor is further configured to execute the computer-executable instructions to receive a selection of a bit in the classical register in which a measurement value of the measurement operation is to be stored.

11. The system of claim 8, wherein the one or more selected symbols comprises a plurality of selected symbols and the user input is first user input, and wherein the at least one processor is further configured to execute the computer-executable instructions to:
receive second user input indicative of a request to generate a subroutine;
receive third user input indicative of a set of the plurality of selected symbols to include in the subroutine and a number of qubits that the subroutine operates on;
generate the subroutine; and
add a symbol representative of the subroutine to the set of symbols in the user interface to enable selection of the symbol and inclusion of the subroutine in the quantum circuit.

12. The system of claim 11, wherein the at least processor is further configured to execute the computer-executable instructions to:
receive fourth user input indicative of selection of the symbol representative of the subroutine;
render, in the user interface, a number of markers equal to the number of qubits that the subroutine operates on; and
receive fifth user input indicating an association between each marker and a corresponding interactive element of the set of interactive elements.

13. A computer program product for composing a quantum circuit, the computer program product comprising a non-transitory storage medium readable by a processing circuit, the storage medium storing instructions executable by the processing circuit to cause a method to be performed, the method comprising:
providing a user interface comprising:
a set of interactive elements corresponding to qubits of a physical quantum processor, wherein each interactive element represents a progression of quantum information over time in a respective qubit; and
a set of symbols, wherein each symbol is representative of a corresponding operation capable of being performed on one or more of the qubits;
receiving user input indicative of: i) one or more symbols selected from the set of symbols, ii) a corresponding one or more interactive elements with which the one or more symbols are associated, and iii) a temporal order in which the one or more symbols are associated with the one or more interactive elements; and
composing the quantum circuit based at least in part on the user input, wherein composing the quantum circuit comprises generating and displaying a graphical representation of the quantum circuit that includes the one or more symbols rendered in association with the one or more interactive elements in accordance with the temporal order.

14. The computer program product of claim 13, the method further comprising executing a simulation of the quantum circuit.

15. The computer program product of claim 13, further comprising executing the quantum circuit on the physical quantum processor.

16. The computer program product of claim 13, wherein the one or more selected symbols includes a particular symbol representative of a multi-qubit gate operation, and wherein receiving the user input further comprises receiving a selection of a first interactive element corresponding to a first qubit for the multi-qubit gate operation and a selection of a second interactive element corresponding to a second qubit for the multi-qubit gate operation, the method further comprising:
determining that a particular qubit is unavailable for selection as the second qubit based at least in part on the selected first qubit; and
modifying a third interactive element in the user interface to make the third interactive element unselectable, wherein the third interactive element corresponds to the particular qubit.

17. The computer program product of claim 13, wherein the user interface further comprises an interactive element corresponding to a classical bit register, and wherein the one or more selected symbols comprises a particular symbol representative of a measurement operation, the method further comprising receiving a selection of a bit in the classical bit register in which a measurement value of the measurement operation is to be stored.

18. The computer program product of claim 13, wherein the one or more selected symbols comprises a plurality of selected symbols and the user input is first user input, the method further comprising:
receiving second user input indicative of a request to generate a subroutine;
receiving third user input indicative of a set of the plurality of selected symbols to include in the subroutine and a number of qubits that the subroutine operates on;
generating the subroutine;
adding a symbol representative of the subroutine to the set of symbols in the user interface to enable selection of the symbol and inclusion of the subroutine in the quantum circuit;
receiving fourth user input indicative of selection of the symbol representative of the subroutine;
rendering, in the user interface, a number of markers equal to the number of qubits that the subroutine operates on; and
receiving fifth user input indicating an association between each marker and a corresponding interactive element of the set of interactive elements.

19. A web-based system for composing a quantum circuit, the web-based system comprising:
a server storing a graphical user interface (GUI) for composing the quantum circuit, the GUI comprising:
a set of interactive elements corresponding to qubits of a physical quantum processor, wherein each interactive element represents a progression of quantum information over time in a respective qubit; and
a set of symbols, wherein each symbol is representative of a corresponding operation capable of being performed on one or more of the qubits; and
wherein the GUI enables selection of any symbol in the set of symbols and association of the selected symbol with one or more of the interactive elements, and wherein association of the selected symbol with the one or more interactive elements indicates that the corresponding operation for the selected symbol is to be performed in the quantum circuit on one or more qubits corresponding to the one or more interactive elements.

20. The web-based system of claim 19, wherein the server is configured to send the GUI to a client device that is configured to present the GUI on a display of the client device.

21. The web-based system of claim 19, wherein the set of symbols comprises a particular symbol representative of a parameterized operation, and wherein the server is configured to query a user for one or more parameter values to associate with the parameterized operation responsive, at least in part, to selection of the particular symbol and association of the particular symbol with the one or more interactive elements.

22. The web-based system of claim 19, wherein the set of symbols comprises a particular symbol representative of a barrier, and wherein selection and association of the particular symbol with the set of interactive elements causes a separation between a first portion of the quantum circuit and a second portion of the quantum circuit that prevents concatenation of a first operation in the first portion with a second operation in the second portion during compilation.

23. The web-based system of claim 19, wherein the server is configured to generate a text-based script corresponding to the quantum circuit and send the text-based script to a client device that is configured to present the text-based script on a display of the client device in association with the GUI.

24. A method for dynamically generating a graphical representation of a quantum circuit, the method comprising:
providing a command line interface;
receiving commands through the command line interface in a gate representation language;
determining, based at least in part on the commands, a set of operations, a set of qubits to which the set of operations are to be applied, and a temporal order in which the set of operations is to be applied to the set of qubits; and
generating and displaying the graphical representation of the quantum circuit, wherein the graphical representation indicates a set of symbols corresponding to the set of operations and a set of linear interactive elements corresponding to the set of qubits, and wherein placement of the set of symbols along the set of linear interactives elements indicates the temporal order.

25. The method of claim 24, further comprising:
determining that at least one command has been modified;
determining a modification to the quantum circuit based at least in part on the modified at least one command; and
dynamically modifying the graphical representation to reflect the modification to the quantum circuit.
